(19) United States
(12) Patent Application Publication
(10) Pub. No.: US 2017/0260781 A1
(43) Pub. Date: Sep. 14, 2017

(54) DOOR SECURITY DEVICE

(71) Applicant: Shiffler Equipments Sales, Inc., Chardon, OH (US)

(72) Inventors: John W. Shiffler, Mentor, OH (US); Steven T. Webb, Concord, OH (US); John R. Erickson, Concord, OH (US); Charles R. Anspach, Concord, OH (US); Zeljko T. Medved, Mentor, OH (US)

(21) Appl. No.: 15/066,423

(22) Filed: Mar. 10, 2016

(51) Int. Cl. E05C 19/00; E05B 13/00; E05C 19/18

(52) U.S. Cl. CPC E05C 19/003; E05C 19/184; E05C 19/186; E05B 13/002

(57) ABSTRACT

A door security device includes a support bar, a first support member, a second support member, and an engagement portion. The first support member is provided on one end of the support bar and is adapted to abut against a surface of an associated door. The second support member is provided at another end of the support bar and is adapted to abut an associated structural surface. The engagement portion is secured to the support bar and is configured to releasably engage a door part of the associated door or an emergency entry device affixed to the associated door. The engagement portion applies a pulling force on the door part in a direction toward the support bar.

### BACKGROUND

One-way doors, which open by swinging in only one direction, are popular in commercial buildings, schools, and the like because they provide easy ingress and egress to and from the building. Out-swinging doors in schools and commercial buildings are often equipped with panic-bar handles. A panic-bar handle may include an elongated rod extending across the width of the door. By pushing against the rod, the door latch is released and the door may be opened. If a crowd of people are pushed up against the door, the weight of the crowd will depress the rod and the door will open. Similarly, if a person is in a hurry to open the door, the person need not stop to turn a conventional doorknob to unlatch the door. The person need only exert a force on the rod and the door will open.

One-way doors can also be targets for burglars. Doors which open in an outward fashion can often be readily opened, even if locked. A pry bar or similar tool can be wedged between the door and the door frame, and the door can be pried open. Devices are known which are permanently or semi-permanently attached to the door or the door frame. For example, a support bar can be bolted to the door or across the door frame, preventing the door from being opened. This type of arrangement, however, defeats the purpose of the panic-bar handle. For example, under exigent circumstances, if the door must be quickly opened, the permanent security device is not readily removable, and thus the door cannot be quickly opened, creating a potential safety issue.

Some security devices require additional hardware to be mounted to the door or the door frame and can require special tooling. Furthermore, it can be difficult and time consuming to mount these devices. Such devices may also leave permanent marks or otherwise deface the door once the devices have been installed and removed. Further, some security devices are also limited in that they are compatible with a particular or specific door or type of door. Once the necessary hardware is attached to the door or door frame of a first door, the security device can only be used on that particular door. To use the security device on another door or a second door, the hardware must be removed from the first door and placed on the second door.

### BRIEF DESCRIPTION

According to one aspect, a door security device for an associated door includes a support bar, a first support member, a second support member, and an engagement portion. The support bar has a first end and a second end. The first support member is provided on the first end of the support bar and the first support member is adapted to abut a surface of the associated door. The second support member is provided on the second end of the support bar. The second support member is adapted to abut an associated structural surface spaced and separate from the surface of the associated door. The engagement portion is secured to the support bar and configured to releasably engage a door part of the associated door. The engagement portion is configured to apply a pulling force on the door part in a direction toward the support bar.

According to one aspect, a door security device for an associated door is provided, including a support bar having a first end and a second end, a first support member provided on the first end of the support bar, the first support member adapted to abut a surface of the associated door, a second support member provided on the second end of the support bar, the second support member adapted to abut an associated structural surface spaced and separate from the surface of the associated door, and an engagement portion secured to the support bar and configured to releasably engage an emergency entry device mounted to the surface of the associated door, the engagement portion applying a pulling force on the emergency entry device in a direction toward the support bar.

According to one aspect, a method for securing a door security device against an associated door including positioning a first support member of the door security device against a surface of the associated door, positioning a second support member of the door security device against an associated structural surface spaced and separate from the surface of the associated door, and actuating an engagement portion of the door security device such that the engagement portion applies a pulling force on a door part of the associated door in a direction toward a support bar of the door security device.

### BRIEF DESCRIPTION OF THE DRAWINGS

FIG. 1 is an exploded view of an exemplary door security device, according to one or more embodiments.

FIG. 2 is a top perspective view of the exemplary door security device of FIG. 1 in an assembled condition.

FIG. 3 is a side perspective view of the exemplary door security device of FIG. 2 disengaged from a door part of an associated door.

FIG. 4 is a side perspective view of the exemplary door security device of FIG. 2 engaged with an exemplary emergency entry device affixed to an associated door, according to one or more embodiments.

FIG. 5 is a side perspective view of the exemplary door security device of FIG. 2 engaged with another door part of an associated door.

FIG. 6 is a side cut-away view of the exemplary door security device of FIG. 2.

FIG. 7 is a side perspective view of a first portion of the exemplary emergency entry device.

FIG. 8 is a side perspective view of a second portion of the exemplary emergency entry device.

FIG. 9 is a perspective view of an exemplary emergency entry key engaging the first portion of the exemplary emergency entry device.

FIG. 10 is a top perspective view of another exemplary door security device, according to one or more embodiments.

FIG. 11 is a side perspective view of the exemplary door security device of FIG. 10 engaged, in a first position, with a door part of an associated door, according to one or more embodiments.

### DETAILED DESCRIPTION

It should, of course, be understood that the description and drawings herein are merely illustrative and that various modifications and changes can be made in the structures disclosed without departing from the present disclosure. In general, the figures of the exemplary door security device may not be to scale. It will also be appreciated that the various identified components of the exemplary door security device disclosed herein are merely terms of art that may vary from one manufacturer to another and should not be deemed to limit the present disclosure.

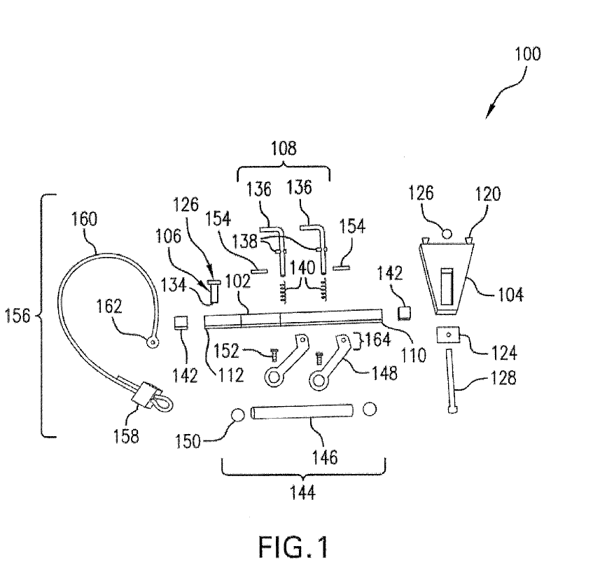

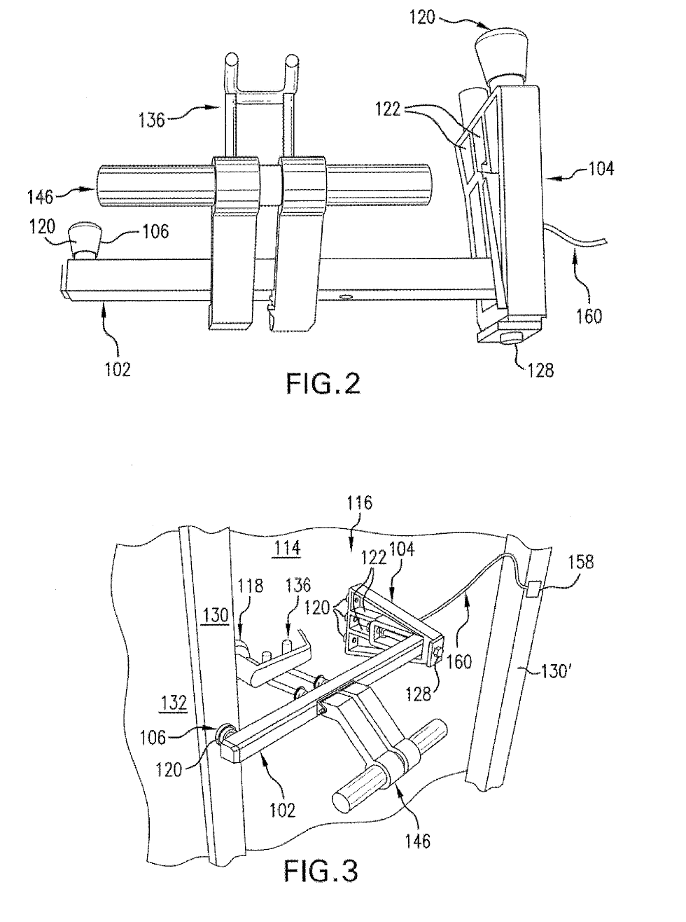

Referring now to the drawings, wherein like numerals refer to like parts throughout the several views, FIG. 1 is an illustration of an exploded view of a door security device 100, while FIG. 2 is an illustration of a top perspective view of the exemplary door security device 100 (in an assembled condition), according to one or more embodiments. The door security device 100 of FIG. 1 can include a support bar 102, a first support member 104, a second support member 106, and an engagement portion 108. The support bar 102 has a first end 110 and a second end 112, can be formed of most any suitable rigid material, such as steel, and can be generally considered the backbone or hub of the door security device 100 in that many of the herein described components or elements of the door security device 100 are provided on, affixed to, or connected to the support bar 102.

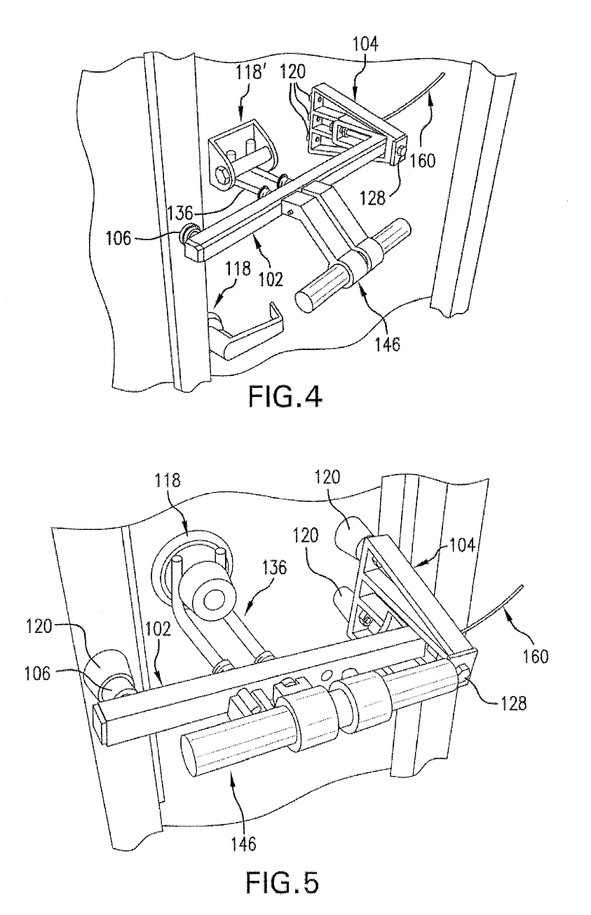

The first support member 104 of the door security device 100 can be provided on one of the first and second ends 110 and 112 and of the support bar 102 and is adapted to abut a surface (e.g., 114 of FIG. 3) of an associated door 116. In other words, the first support member 104 can be a support member which rests against the surface 114 of the associated door 116 when the door security device 100 is engaged with a door part (e.g., 118 of FIG. 3) of the associated door 116. The first support member 104 can include feet 120 which are adapted to abut against the surface 114 of the associated door 116. It will be appreciated that the door part 118 can be a latch actuator, a door handle, a door knob, an exemplary emergency entry device (e.g., 118′ of FIG. 4) removably mounted to the door, a fixture on the door, and the like. For conciseness and ease of discussion, the above examples shall be referred to herein as ‘door part’.

As depicted in FIGS. 2 and 3, the first support member 104 can have one or more reinforcing ribs 122 which define a cavity shaped to receive one of the first and second ends 110 and 112 of the support bar 102. The first support member 104 can be provided or attached to the support bar 102 using any means known in the art. For example, returning to FIG. 1, a washer 124 (e.g., provided to reinforce a support attachment point), nut 126, and attachment bolt 128 can be provided to affix the first support member 104 to the support bar 102. Here, the nut 126 is configured to secure the attachment bolt 128 to the first support member 104 and the first end 110 of the support bar 102. The first support member 104 can be trapezoidal in shape, although other shapes are possible, such as triangular, for example.

As shown in FIG. 3, the second support member 106 is adapted to abut another structural surface other than the surface 114 of the associated door 116, such as a surface 130 of a door frame or a surface 132 of an adjacent wall. The second support member 106 can be provided on the other of the first and second ends 110 and 112 of the support bar 102 opposite the first support member 104. In this way, the second support member 106 is adapted to abut an associated structural surface (e.g., surfaces 130 or 132 of FIG. 3) spaced and separate from the surface 114 of the associated door 116 against which the first support member 104 abuts. In other words, the second support member 106 is adapted to abut a structural surface which is not a part of the associated door 116. Examples of such a structural surface can include a surface of another door, the surface 130 of the door frame of the associated door 116, a surface away from the surface 114 of the associated door 116, such as the surface of the adjacent wall offset from the associated door 116 (e.g., surface 132 of FIG. 3), and the like.

In the depicted embodiment shown in FIGS. 1-3, the second support member 106 is an adjustable member which is configured or adapted to span a distance between the associated structural surface 130, 132 and the support bar 102. For example, the second support member 106 can include a base portion or feet 120 (adapted to rest against the associated structural surface) and a threaded portion 134 which screws into a corresponding opening in the support bar 102, thereby enabling adjustment of the distance between the associated structural surface 130, 132 (or feet 120 of the second support member 106) and the support bar 102.

Similarly, adjustable feet 120 can also be provided on the first support member 104, thereby enabling the door security device 100 to be customized to fit to most any door through the adjustment of the positioning of the feet 120 on either support member 104 or 106. For example, the feet 120 are adjustable when provided with a rotating action to increase or decrease the distance between the support bar 102 and the surface 114 of the associated door 116 or other associated structural surface. Because the feet 120 of the first and second support members 104 and 106 are adjustable in this manner, this results in the door security device 100 being compatible with nearly any door configuration.

Because the first support member 104, the second support member 106, and the engagement portion 108 are adapted to abut surfaces, and grab the door part 118 all on the same side of the door, it is not necessary for an operator to open the associated door 116 in order to utilize the door security device 100, which can be advantageous during an emergency (e.g., lockdown) scenario. In other words, the operator may safely lock the associated door 116 using the door security device 100 without exiting the room or opening the associated door 116 to engage the door security device 100. Further, the door security device 100 does not prevent a door latch (not shown) of the associated door 116 from engaging a latch box (not shown).

The engagement portion 108 of the door security device 100 is secured to the support bar 102 and is configured to releasably engage the door part 118. This releasably engaged configuration can be achieved when the first support member 104 abuts the surface 114 of the associated door 116 and the second support member 106 abuts the associated structural surface (e.g., 130 of FIG. 3), providing leverage for the engagement portion 108 to engage the door part 118. In this way, the engagement portion 108 can cause the door security device 100 to prevent or mitigate ingress or egress through the associated door 116 by applying a pulling force on the door part 118 in a direction toward the support bar 102.

According to one aspect, the engagement portion 108 can include at least one hook 136. In the depicted embodiment, a pair of hooks 136 is provided for the engagement portion 108. Each hook 136, which can be openably connected to the support bar 102 through an opening in the support bar 102, includes a tab 138. The hooks 136 can be configured to hold the door part 118, thereby applying pressure (e.g., in a direction toward the support bar 102) against the door part 118. As an example, the engagement portion 108 can engage the door part 118 by holding the door part 118 firm with the hooks 136. Thus, the engagement portion 108 can ‘grab’ the door part 118, enabling the door security device 100 to maintain the associated door 116 in a closed position, thereby serving as a secondary locking device.

It should be appreciated that the support bar 102 and the engagement portion 108 can be configured such that the spacing between the hooks 136 of the engagement portion 108 is adjustable or there are multiple discrete openings which the hooks 136 may be selectively placed, thereby enabling the door security device 100 to be compatible with different door configurations.

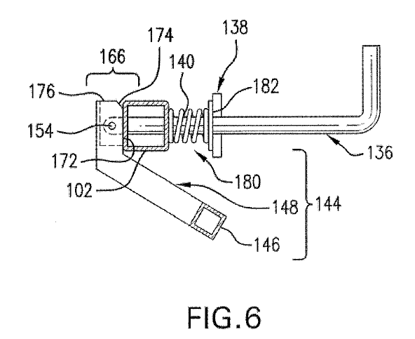

As shown in FIG. 1, a biasing member, such as a spring 140, can be interposed between each hook 136 (i.e., the engagement portion 108) via a tab 138 and the support bar 102 to bias the engagement portion 108 in a direction away from the support bar 102. As depicted, each spring 140 can be configured to slide over a portion of one of the hooks 136 (and be in contact with the tab 138 such that the tab 138 terminates movement of each spring 140, thereby causing compression of the spring 140) to provide pressure and action for engaging and disengaging the hooks 136 of the engagement portion 108 from the door part 118, as will be described in greater detail in FIG. 6, which provides a cut-away view of the door security device 100.

In one or more embodiments, the door security device 100 can include other components, such as end plugs 142 adapted to fit in the first and second ends 110 and 112 of the support bar 102. Further, the door security device 100 can include a handle assembly 144. The handle assembly 144 can be operatively connected to the engagement portion 108 through openings in the support bar 102. The handle assembly 144 can include a lever 146 movable between a first position and a second position (e.g., an actuated position and an unactuated position or a locked position and a unlocked position), at least one connecting member 148, end caps 150, and a screw or pin 154.

Further, one end of the lever 146 of the handle assembly 144 can be pivotably secured to the support bar 102 such that the lever 146 is movable between the first and second positions (e.g., actuated and unactuated positions) by pivoting the lever 146 relative to the support bar 102. In this way, the door security device 100 can be engaged or disengaged quickly and easily.

The handle assembly 144 is configured to pivot relative to the support bar 102 and is depicted in an upright, actuated position in FIGS. 2, 5, 10, and 11. As a result of the handle assembly 144 being in the actuated position, the engagement portion 108 is engaged with the door part 118 and is configured to apply a pulling force on the door part 118 toward the support bar 102. The handle assembly 144 is depicted in a lower, unactuated position in FIG. 3. As a result of the handle assembly 144 being in the unactuated position, the engagement portion 108 is configured to release the pulling force on the door part 118. When the handle assembly 144 is in the unactuated position, the hooks 136 may not necessarily be in contact with the door part 118 and do not apply the pulling force on the door part 118 toward the support bar 102. In other words, when the handle assembly 144 is in the unactuated position, the hooks 136 apply no force on the door part 118.

It will be appreciated that in other embodiments (e.g., FIG. 6), the downward or lower position of the handle assembly 144 can be configured to provide the pulling force on the emergency entry device 118′ or the door part 118 such that the downward position is the actuated position rather than the upper position.

Thus, the handle assembly 144 is configured to cause the engagement portion 108 to apply different forces (e.g., pulling or no force) on the door part 118, depending on the position of the lever 146. Referring to FIG. 3, the handle assembly 144 is configured to cause the engagement portion 108 to apply no force on the door part 118 when the lever 146 of the handle assembly 144 is in an unactuated position. The lever 146 pushes the engagement portion 108 in a direction toward the surface 114 of the associated door 116, into the unactuated position, thereby releasing pressure between the door security device 100 and the door part 118. Here, the hooks 136 of the engagement portion 108 can be in slight contact or have no contact with the door part 118.

FIG. 4 is an illustration of a different embodiment of the exemplary door security device 100 engaged on the emergency entry device 118′, which is affixed to the associated door 116. Here, operation and the configuration of the door security device 100 is similar to the configuration shown in FIG. 3, except that the engagement portion 108 is hooked on or engaged with the emergency entry device 118′ rather than the door part 118 of the associated door 116 and the exemplary door security device 100 of FIG. 4 is engaged, rather than disengaged. In FIG. 4, the lever 146 of the handle assembly 144 is depicted in an upward (relative to other Figs., due to the angle of the connecting member 148), actuated position and corresponds to a pulling force being applied to the emergency entry device 118′ by the hooks 136 of the engagement portion 108.

In FIG. 5, the engagement portion 108 applies a pulling force on the door part 118 when the lever 146 of the handle assembly 144 is in an actuated position, causing the exemplary door security device 100 to be engaged with the door part 118. As depicted in FIG. 5, the engagement portion 108 includes the two hooks 136, which are configured to secure the door security device 100 against the door knob (e.g., door part 118) of the associated door 116. In this embodiment, lifting of the handle assembly 144 (into the upright position) causes the hooks 136 to apply pressure (e.g., a force in a direction toward the support bar 102) against the door part 118, thereby maintaining the door in a closed position and mitigating entry, ingress, or egress. When the lever 146 of the handle assembly 144 is in the actuated position causing a pulling force to be applied on the door part 118, the lever 146 pulls the engagement portion 108 in a direction toward the support bar 102, creating the pulling force in the same direction.

Returning to FIG. 1, the lever 146 can be connected to the support bar 102 via the at least one connecting member 148. The connecting member 148 connects the engagement portion 108 and the lever 146 of the handle assembly 144 through openings in the support bar 102. Fasteners or other attachment means, such as a pin 152, can attach the connecting member 148 to the lever 146 of the handle assembly 144. The pin 154 (or other fastening or attachment means known in the art) can be used to attach the lever 146 of the handle assembly 144 to the connecting member 148. The handle assembly 144 and lever 146 rotate relative to the support bar 102 at a fixed point corresponding to the pin 154. In this way, the handle assembly 144 rotates about an axis defined by the pin 154.

Further, with reference to FIG. 3, an attachment assembly 156 can be provided to mount the door security device 100 to an adjacent or associated attachment surface 130′ offset from the associated door 116. By way of example, the attachment assembly 156 can include an attachment member 158 adapted to be affixed to the adjacent attachment surface 130′, a tether cable 160, and attachment portion 162 adapted to be attached to the support bar 102 or the first support member 104. That is, the attachment surface 130′ can be a frame 130 of the associated door 116, the surface of another door, or the wall 132 offset from the associated door 116. Further, the door security device 100 can be tethered to the door frame or attachment surface 130′ or wall by the tether cable 160. In other words, one end of the tether cable 160 can be connected to a portion of the door security device 100, such as the support bar 102, the first support member 104, the second support member 106, and the like. In this way, the door security device 100 is tethered to the associated door 116 or attachment surface 130′ via the tether cable 160 such that when the door security device 100 is disengaged from the door part 118, the door security device 100 is located out of the way of ingress or egress (e.g., does not block the doorway) and is not a tripping hazard.

As is evident from the foregoing, the door security device 100 can be a mechanically operated, secondary locking device that can be applied to most any existing door having a handle (or a removably mounted door part) and the door surface 114. When the door security device 100 is engaged with the door part 118, it can prevent or mitigate ingress or egress through the door, such as during emergency situations or lockdown scenarios, by applying compression force between the door and the frame of the door. Thus, the door security device 100 is not required to be permanently affixed to the door.

FIG. 6 is an illustration of a side cut-away view of the exemplary door security device 100, where the handle assembly 144 is in the unactuated position while downward, unlike other figures (e.g., FIG. 5, among others) of the instant application where the handle assembly 144 is in the actuated position while upright. In the illustrative embodiment shown, the handle assembly 144 is connected to the support bar 102 through the at least one connecting member 148. The end 164 of each connecting member 148 is pivotally connected to the support bar 102. Here, the pin 154 is disposed through a stem of the connecting member 148, such that the connecting member 148 can pivot or rotate about an axis defined by the pin 154, thereby allowing the connecting member 148 and handle assembly 144 to pivot with respect to the support bar 102. This enables the pin 154 to act as a pivot point for a camming surface 166 defined by the connecting member 148.

The camming surface 166 contacts the support bar 102 as the handle assembly 144 is pivoted with respect to the support bar 102. The camming surface 166 can be any shape, such as round, elliptical, multi-step, or the like. In the embodiment shown in FIG. 6, the camming surface 166 includes three discrete surfaces, a first surface 172, a second surface 174, and a third surface 176. The first surface 172 and the third surface 176 are substantially orthogonal to one another, and are connected by the second surface 174, which is angled respect to the first and third surfaces 172 and 176. After actuation of the engagement portion 108, the third surface 176 is substantially vertical and the first surface 172 is substantially horizontal with reference to a ground plane. In this example, the second surface 174 extends at an angle of 45 degrees from the first surface 172 and the third surface 176, although other variations of angles are contemplated.

The door security device 100 includes a biasing assembly 180. In this example, the biasing assembly 180 includes a washer 182, and the spring 140. The spring 140 is positioned about an end portion of the hook 136 such that the spring 140 substantially surrounds the hook 136. The washer 182 is secured to the end portion of the hook 136 adjacent one end of the spring 140 at the tab 138 of the hook 136. The opposite end of the spring 140 abuts the support bar 102.

The biasing assembly 180 acts as an aid to release the door security device 100 from the actuated position to the unactuated position (e.g., first position and second position). When door security device 100 is actuated, the spring 140 is compressed, exerting a force on the support bar 102 and on the washer 182. The force on the washer 182 is directed away from the support bar 102, thus tending to push the hook 136 away from the support bar 102, to the unactuated position or released position. When a user is releasing the handle assembly 144, the user is assisted in pushing the handle toward the door by the biasing force of the spring 140 against washer 182 and tab 138 on the hook 136.

The door security device 100 can be positioned such that the engagement portion 108 grabs the door part 118 of the associated door 116. The door security device 100 is actuated by pivoting the handle assembly 144 relative to the support bar 102. In FIG. 6, actuation occurs when the handle assembly 144 is pivoted downward. As the handle assembly 144 is pivoted, surfaces 172, 174, and 176 of the camming surface 166 on the connecting member 148 contact the support bar 102 (beginning with 172 and ending with 176 from the unactuated position to the actuated position). From the unactuated position, the first surface 172 rests substantially flush against the support bar 102. As the handle assembly 144 is rotated, the first surface 172 rotates away from the support bar 102 and the second (e.g., angled) surface 174 rotates to be in contact with the support bar 102. When the handle assembly 144 is fully actuated (e.g., moved from a first position into a second position), the third surface 176 rests substantially flush against the support bar 102.

As the handle assembly 144 is actuated, the surfaces 172, 174, and 176 of the camming surface 166 rotate against the support bar 102, drawing each hook 136 toward the support bar 102. This pulling force is caused by the increase in distance between the pin 154 and the support bar 102 as a result of the first surface 172, the second surface 174, and the third surface 176 coming in contact with the support bar 102. In this way, each hook 136 is pulled toward the support bar 102, thereby compressing the spring 140 via the tab 138 of the hook 136 toward the support bar 102. Thus, the biasing assembly 180 provides tension which holds the engagement portion 108 and handle assembly 144 in place, securing the associated door 116 in the closed position.

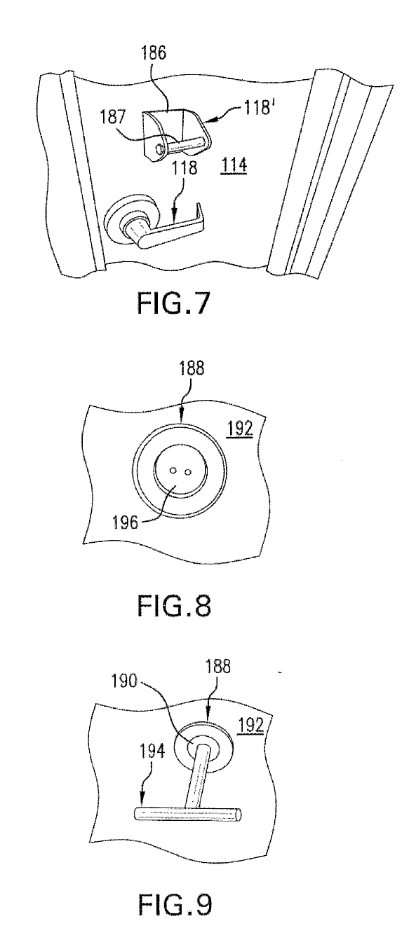

FIG. 7 is an illustration of a side perspective view of a first portion 186 of the exemplary emergency entry device 118′, which can be a separate component that is releasably mounted to the associated door 116 and engaged with the engagement portion 108 of the door security device 100. Here, the first portion 186 of the emergency entry device 118′ is affixed to a first side of the door (e.g., associated with surface 114). For example, the first portion 186 of the emergency entry device 118′ can be inserted through an opening (not visible) in the associated door 116. The first portion 186 of the emergency entry device 118′ can be utilized similarly to the door part 118 for engagement with the engagement portion 108 of the door security device 100, rather than the latch actuator, door handle, door knob, or other appendage or fixture associated with the door. As depicted, the emergency entry device 118′ includes an engagement portion 187 and is configured to be grabbed or engaged by the engagement portion 108 of the door security device 100.

FIG. 8 is an illustration of a side perspective view of a second portion 188 of the exemplary emergency entry device 118′ having a key slot 190. On an opposing side or second side 192 of the associated door of FIG. 7, the second portion 188 of the emergency entry device 118′ is installed by inserting the second portion 188 through the same opening (not visible) as the first portion 186 of the emergency entry device 118′.

The first portion 186 and the second portion 188 of the emergency entry device 118′ are configured to be coupled (thereby being affixed to the door) or decoupled. In this regard, an emergency entry key 194, shown in FIG. 9, can be provided to releasably connect the first and second portions 186 and 188 of the emergency entry device 118′. The emergency entry key 194, when engaged in a first position with the second portion 188 of the emergency entry device 118′ through the key slot 190, is used to cause the first portion 186 and the second portion 188 to attach to one another, with the associated door 116 as an intermediary. Conversely, when the emergency entry key 194 is engaged in a second position, with the second portion 188 of the emergency entry device 118′ (which includes the first portion 186 and the second portion 188), the first portion 186 detaches from the first side 114 of the door and/or the second portion 188 detaches from the second side 192 of the door. Thus, if emergency entry is required, such as by proper authorities (e.g., fire department, police, emergency responders, and the like.), the emergency entry key 194 can be used to unlock the door equipped with an emergency entry device 118′ from an exterior (e.g., second portion 188) side 192 of the door.

By way of example, the emergency entry key 194 can be inserted into the key slot 190 of the second portion 188. When the emergency entry key 194 is inserted in the key slot 190, the emergency entry key 194 is rotatable between the first position and the second positions. Thus, to mount the emergency entry device 118′ to the associated door 116, a user would insert the first portion 186 of the emergency entry device 118′ through the opening of the associated door 116 from the first side 114 of the door, insert the second portion 188 of the emergency entry device 118′ through the opening from the second side 192 of the door, insert the emergency entry key 194 into the key slot 190 of the second portion 188, and rotate the emergency entry key 194 from the second position to the first position.

To remove or un-mount the first portion 186 and the second portion 188 of the emergency entry device 118′, the user would perform the reverse by inserting the emergency entry key 194 into the key slot 190 of the second portion 188, and rotating the emergency entry key 194 from the first position to the second position, causing the first portion 186 and the second portion 188 of the emergency entry device 118′ to decouple. As a result of this decoupling, the door security device 100 positioned such that the engagement portion 108 of the corresponding door security device 100 is engaged with the first portion 186 of the emergency entry device 118′ will release the engagement portion 108 from the emergency entry device 118′. In other words, decoupling of the first and second portions 186 and 188 of the emergency entry device 118′ will result in disengaging of the door security device 100 on the other side of the door.

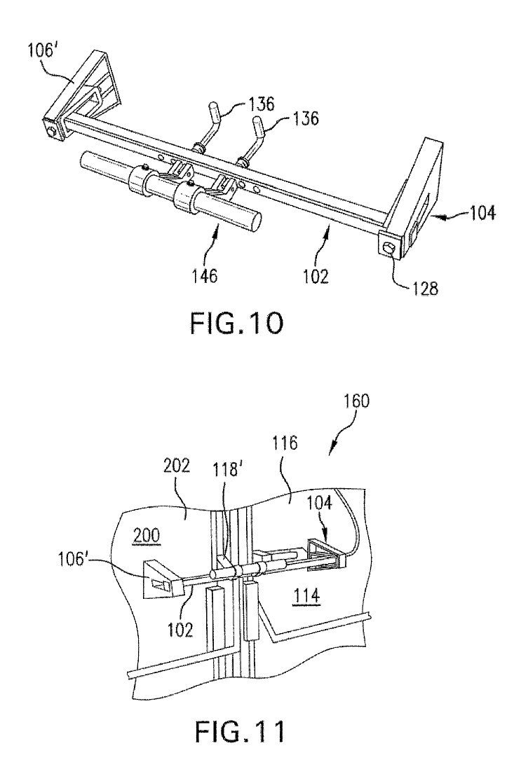

FIG. 10 is an illustration of the exemplary door security device 100, according to another embodiment. In this embodiment, a second support member 106′ is adapted to be abutted against the surface of another door (e.g., 200 depicted in FIG. 11), rather than the surface of the door frame (e.g., 130 of FIG. 3). As such, the second support member 106′ can be identical to the first support member 104 and is affixed to one end 112 of the support bar 102.

FIG. 11 is an illustration of the exemplary door security device 100 engaged, with the emergency entry device 118′ mounted on one of door 116 and door 202. Similarly to FIG. 5, the handle assembly 144 is in an upright position, causing the hooks 136 (not visible) of the engagement portion 108 to engage with the emergency entry device 118′ mounted on one of the doors 116 and 202 and apply a pulling force toward the support bar 102, resulting in preventing ingress or egress through either door 116 and 202.

As is evident from the forgoing, the present disclosure provides a method for securing a door security device 100 against an associated door 116. The method includes positioning a first support member 104 of the door security device 100 against a surface 114 of the associated door 116, positioning a second support member 106 of the door security device 100 against an associated structural surface 130, 132 spaced and separate from the surface 114 of the associated door 116, and actuating an engagement portion 108 of the door security device 100 such that the engagement portion 108 applies a pulling force on a door part 118 of the associated door 116 in a direction toward a support bar 102 of the door security device 100. The method can include mounting an emergency entry device 118′ to the associated door 116 and actuating the engagement portion 108 of the door security device 100 such that the engagement portion 108 applies the pulling force on the emergency entry device 118′ in the direction toward the support bar 102 of the door security device 100.

It will be appreciated that several of the above-disclosed and other features and functions, or alternatives or varieties thereof, can be desirably combined into many other different systems or applications. Also that various presently unforeseen or unanticipated alternatives, modifications, variations or improvements therein can be subsequently made by those skilled in the art which are also intended to be encompassed by the following claims.

1. A door security device for an associated door, comprising:
a support bar having a first end and a second end;
a first support member provided on the first end of the support bar, the first support member adapted to abut a surface of the associated door;
a second support member provided on the second end of the support bar, the second support member adapted to abut an associated structural surface spaced and separate from the surface of the associated door; and
an engagement portion secured to the support bar and configured to releasably engage a door part of the associated door, the engagement portion applying a pulling force on the door part in a direction toward the support bar.

2. The door security device of claim 1, wherein the engagement portion comprises a hook connected to the support bar and configured to hold the door part of the associated door.

3. The door security device of claim 2, further comprising a biasing member biasing the hook in the direction toward the support bar so as to cause the hook to apply the pulling force on the door part when the hook holds the door part.

4. The door security device of claim 1, further comprising a handle assembly connected to the engagement portion and operable to cause the engagement portion to apply the pulling force on the door part of the associated door.

5. The door security device of claim 1, further comprising a handle assembly including a lever operatively connected to the engagement portion and the support bar, the lever is movable between an actuated position and an unactuated position, the lever pulling the engagement portion in the direction toward the support bar when in the actuated position and releasing the engagement portion when in the unactuated position.

6. The door security device of claim 5, wherein the lever is pivotably secured to the support bar.

7. The door security device of claim 1, wherein the second support member includes an adjustable member abutting the associated structural surface, the adjustable member configured to adjust a distance between the associated structural surface and the support bar.

8. The door security device of claim 1, wherein the associated structural surface is a frame of the associated door, a surface of another door, or a wall offset from the associated door.

9. The door security device of claim 1, further comprising an attachment member configured to be secured to an associated attachment surface separate from and offset from the associated door, the attachment member connected to one of the support bar, the first support member, and the second support member.

10. The door security device of claim 9, wherein the associated attachment surface is a frame of the associated door, a surface of another door, or a wall offset from the associated door.

11. The door security device of claim 1, wherein the door part is a latch actuator, a door handle, or a door knob.

12. The door security device of claim 1, wherein the door part is an emergency entry device releasably mounted to the associated door.

13. The door security device of claim 12, wherein the emergency entry device includes a first portion and a second portion, releasably coupled to the first portion.

14. The door security device of claim 13, wherein the first portion of the emergency entry device has an engagement portion and the second portion of the emergency entry device has a key slot configured to receive an emergency entry key and couple or decouple the first and second portions based on a position of the emergency entry key.

15. A door security device for an associated door, comprising:
a support bar having a first end and a second end;
a first support member provided on the first end of the support bar, the first support member adapted to abut a surface of the associated door;
a second support member provided on the second end of the support bar, the second support member adapted to abut an associated structural surface spaced and separate from the surface of the associated door; and
an engagement portion secured to the support bar and configured to releasably engage an emergency entry device mounted to the surface of the associated door, the engagement portion applying a pulling force on the emergency entry device in a direction toward the support bar.

16. The door security device of claim 15, wherein the emergency entry device includes a first portion and a second portion, and
wherein the first portion is received through an opening from a first side of the associated door and the second portion is received through the opening from a second side of the associated door and releasably coupled to the first portion.

17. The door security device of claim 16, wherein the first portion and the second portion are configured to be coupled or decoupled with an emergency entry key such that the first portion of the emergency entry device detaches from the first side of the associated door when the emergency entry key is engaged with the first portion of the emergency entry device.

18. A method for securing a door security device against an associated door, comprising:
positioning a first support member of the door security device against a surface of the associated door;
positioning a second support member of the door security device against an associated structural surface spaced and separate from the surface of the associated door; and
actuating an engagement portion of the door security device such that the engagement portion applies a pulling force on a door part of the associated door in a direction toward a support bar of the door security device.

19. The method of claim 18, comprising mounting an emergency entry device to the associated door.

20. The method of claim 19, comprising actuating the engagement portion of the door security device such that the engagement portion applies the pulling force on the emergency entry device in the direction toward the support bar of the door security device.
